(19) United States
(12) Patent Application Publication
(10) Pub. No.: US 2004/0100956 A1
(43) Pub. Date: May 27, 2004

(54) Packet search device, packet processing search method used for the same, and program for the same

(76) Inventor: Akira Watanabe, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/716,622

(22) Filed: Nov. 20, 2003

(30) Foreign Application Priority Data
Nov. 20, 2002 (JP) 335904/2002

(51) Int. Cl. H04L 12/56

(52) U.S. Cl. 370/389; 370/252

(57) ABSTRACT

A packet processing search system can speed up and simplify the management of a search database without slowing down search processing. A processing operation device stores a packet received by a packet reception device in a packet storage device, extracts header information, which is data at the top of packet data, and requests a packet search device to search for processing for the packet. A search processing operation device executes search processing by comparing the provided packet header with search conditions stored in a search data storage device and returns the result to the processing operation device. Based on the result, the processing operation device reads a processing operation for the packet from the packet storage device and processes the packet accordingly.

### BACKGROUND OF THE INVENTION

1. Field of the Invention

The invention relates to a packet searching (retrieving) device, a packet processing searching method that is used for the same, and a program for the same, and more particularly, to a packet processing system that performs packet filter search on a router and a firewall and performs packet processing.

2. Description of the Related Art

Conventional packet processing systems and packet filter searching systems for routers and firewalls include a system that prioritizes packets or determines if a packet can be transferred or not based on header information, which is data positioned at a lead of a packet (a first prior art) (see P. Gupta and N. McKeowon, “Packet Classification on Multiple Fields”, ACM SIGCOMM '99, September 1999”, for example). This system adopts such a search technique that divides packet header information into a number of information are a data that is required for searching and performs searches with each information area data as search keys.

As another example of packet filter searching system, a system is known that builds a database structured as a search tree that is provided by improving binary tree search for searching (a second prior art) (see F. Baboescu and G. Varghese, “Scalable Packet Classification”, ACM SIGCOMM '01 August, 2001).

As still another system for packet filter searching system, a system is known that has multiple-staged microprocessors that perform search with Hash method and improves processing speed through pipeline effect (a third prior art) (see Japanese Patent Laid-Open No. 2000-174805).

The first prior art mentioned above, however, has to store information for prioritizing packets and determining possibility of packet transfer as associated with search keys in a search database. Thus, the search database needs to reflect all information corresponding to information area data in a storage device and a large capacity is thus required of a storage device relative to the number of registered conditions. As a result, significant processing capability is required for a controlling CPU (central processing unit) that manages the database.

Although the second prior art can reduce a required memory capacity, when a new search condition is added to the search database or when a search condition is deleted from the database that is already reflected in the storage device, the optimized database need to be rebuilt from scratch. As a result, this technique also requires significant processing capacity for the controlling CPU that manages the search database.

In the third prior art, because processing performed by the microprocessors involves data dependency, management of a search database is complicated and significant processing capability is required for the controlling CPU.

Thus, in the prior arts, processing capability of search methods has been improved and storage area for the search database has been reduced. However, some malicious users may transfer unauthorized packets to routers or the like in recent years. In such a case, the router determines the type of invalidity of such a packet through software processing by the controlling CPU and handles the packet. It consequently leads to a problem that the processing capability of the controlling CPU deteriorates due to handling of such unauthorized packets and the CPU cannot carry out management of routing information that the CPU is essentially responsible for.

As a result, it can significantly affect the operability and reliability of the controlling CPU in the router or the firewall. A system user thus need to identify the user who transfers unauthorized packets and performs filtering operation through hardware processing to prevent such packets to be transferred to the controlling CPU so that the system is protected against external attacks.

Thus, those packet filter search systems described above cause a problem that if only capability of search processing is optimized, a storage device required for a search database must have a large capacity and hence a process of constructing a packet filter search database slows down.

In addition, those prior systems have another problem that if only storage device capacity required for storing the search database is optimized, a process of optimizing the search database is complicated and addition/deletion to/from the database is more complex accordingly, thereby a process of editing the packet filter search database slows down.

An object of the present invention is to provide a packet searching device, a packet processing search method used for the same, and a program for the same that can resolve the problems shown above and speed up and simplify the management of a search database without slowing down search processing.

### SUMMARY OF THE INVENTION

The packet search device according to the invention is a packet search device that performs packet filter search for an inputted packet, comprising a first search processing means for searching for search conditional statements corresponding to a plurality of information areas included in header information of the packet with a first search method, and a second search processing means for searching the search results of the first search processing means with a second search method that is different from the first search method.

The packet processing search method according to the invention is a packet processing search method that searches for a packet filter for an inputted packet before performing packet processing, comprising a first step of searching for search conditional statements corresponding to a plurality of information areas included in header information of the packet with a first search method, and a second step of searching the search results at the first search processing step with a second search method that is different from the first search method.

The program for the packet processing search method according to the invention is a program for the packet processing search method that searches for a packet filter for an inputted packet before performing packet processing, causing a computer to execute a first processing that searches for search conditional statements corresponding to a plurality of information areas included in header information of the packet with a first search method, and a second processing that searches the search results of the first processing with a second search method that is different from the first search method.

That is, the packet processing search system of the invention is characterized in that packet search processing is divided into two processing stages and filter information is searched for with separate search methods.

The first search processing divides packet header information into a plurality of information areas and searches across each search conditional statements structured as binary search trees for each information area separately. The second search processing searches aggregated search results of the first search processing using Hash method.

In such a manner, the invention manages a search database for each information area in terms of results of the first search processing so that management of a search database can be speeded up, and, because the second search processing manages only combinations of search results, information can be simplified.

Thus, viewing it as an overall search processing system, the packet processing search system of the invention can speed up and simplify the management of a search data base without slowing down search processing.

### BRIEF DESCRIPTION OF THE DRAWINGS

FIG. 1 is a block diagram showing a configuration of a packet processing search system according to an embodiment of the invention;

FIG. 2 shows an example of a structure of a target packet in the embodiment of the invention;

FIG. 3 is a block diagram showing processing blocks in a search processing operation device in FIG. 1;

FIG. 4 shows an example of optimization of a search tree in the embodiment of the invention;

FIG. 5 shows an example of optimization of a search tree in the embodiment of the invention;

FIG. 6 generally shows search processing executed in the embodiment of the invention;

FIG. 7 is a flowchart showing search processing executed in the embodiment of the invention;

FIG. 8 shown an example of a structure of a management table for search trees in the embodiment of the invention;

FIG. 9 is a block diagram showing a configuration of the packet processing search system in another embodiment of the invention; and

FIG. 10 is a block diagram showing a configuration of the packet processing search system in still another embodiment of the invention.

### DETAILED DESCRIPTION OF THE PREFERRED EMBODIMENTS

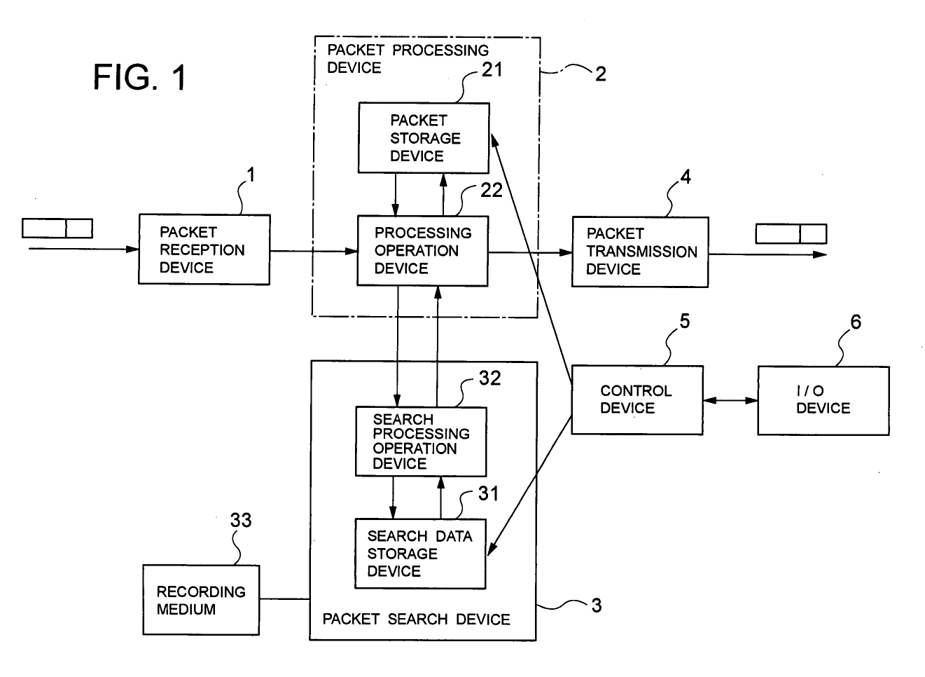

The embodiments of the invention will be described with reference to accompanying drawings. FIG. 1 is a block diagram showing the configuration of a packet processing search system according to an embodiment of the invention. As shown, the packet processing search system of the embodiment consists of a packet reception device 1, packet processing device 2, packet search device 3, packet transmission device 4, control device 5, and an input/output device 6.

The packet reception device 1 receives packets from an outside of the system and the packet transmission device 4 sends packet to the outside of the system. The packet processing device 2 processes packet data and packet search device 3 searches for processing required for a packet based on search conditions information included in the packet data. The control device 5 operates and manages the packet processing device 2 and the packet search device 3, and the I/O device 6 allows a system user to designate processing operations to the control device 5.

The packet reception device 1 is capable of receiving packet data transferred from the outside of the system and transferring them to the packet processing device 2. The packet transmission device 4 is capable of sending packet data processed by the packet processing device 2 to the outside of the system.

The packet processing device 2 comprises a packet storage device 21 for storing packet data and processing operations for stored packets, and a processing operation device 22 for determining a processing operation based on data read out from the packet storage device 21 and executing the processing operation. The processing operations may be editing of packet data, packet transfer or packet discarding and the like as required by the system.

The packet search device 3 consists of a search data storage device 31 in which data such as search conditions required for search processing are stored, and a search processing operation device 32 for executing search processing with data read out from the search data storage device 31. And, to the device 3, a recording medium 33 that stores programs to be executed in a computer when the search processing operation device 32 is implemented by a computer is connected. By this configuration, the packet search device 3 searches for filters for packets and processing operations depending on QoS (Quality of Service) based on header information which is data at the lead of packet data.

The control device 5 receives setting information that the system user sets to the system through the I/O device 6 and stores it in the packet storage device 21, thereby setting processing operations for the packet processing device 2. The control device 5 also stores search conditions received through the I/O device 6 in the search data storage device 31 to set search conditions for the packet search device 3. When setting is completed, the control device 5 informs the system user of the completion through the I/O device 6.

The I/O device 6 is a device with which the system user performs setting for the system, including the setting information and search conditions, and which informs the user of the result of setting.

The operation of the system begins with the system user requesting a setting information for the system with the I/O device 6. Depending on the setting information requested through the I/O device 6, the control device 5 performs the setting either the packet processing device 2 or packet search device 3, based on the setting informtaion.

Packet data received by the packet reception device 1 is transferred to the packet processing device 2. At this point, the processing operation device 22 stores a received packet to the packet storage device 2. The processing operation device 22 extracts header information, which is at the lead of packet data, and requests the packet search device 3 to search for a processing operation for the packet.

The search processing operation device 32 executes search processing for the packet by comparing the packet header provided with search conditions stored in the search data storage device 31 and returns the result to the processing operation device 22. Upon receiving the result, the processing operation device 22 reads out a processing operation for the packet from the packet storage device 21 based on the result and processes the packet.

If the packet is transferred to outside the system because of the type of processing operation, the packet data is sent to the packet transmission device 4. The packet transmission device 4 sends the received packet data to the outside of the system.

When a setting operation is no longer necessary, the system user can request the system to delete the setting through the I/O device 6. Upon receiving such a request, the control device 5 performs the deletion of the setting to the packet processing device 2 and packet search device 3.

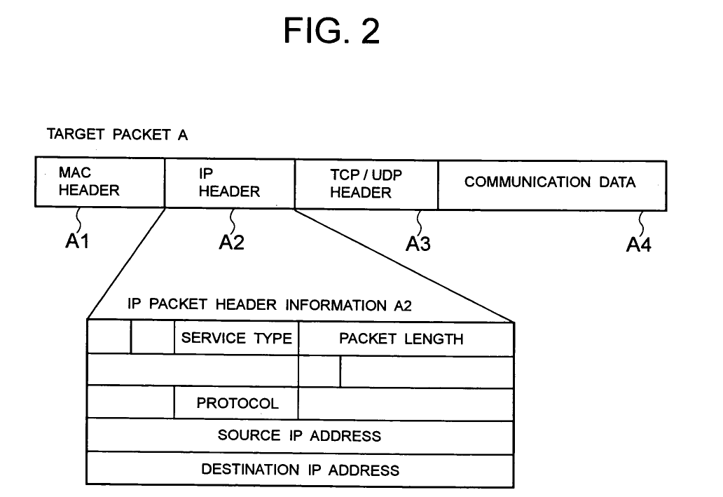

FIG. 2 shows an example of a structure of a target packet in an embodiment of the invention. As shown, the packet A consists of a MAC header A1, an IP (Internet Protocol) header A2, a TCP/UDP (Transmission Control Protocol/User Datagram Protocol) header A3, and communication data A4.

Information areas within a header that are used as search conditions include, in the IP header A2 that is data at the top of packet A, an destination IP address that indicates the destination of the packet, a source IP address indicating where the packet is from, a service type indicating the priority of the packet, a protocol that serves to identify processing operations for the packet, and packet length indicating the packet size and the like, for a hierarchized network. The system user sets conditional statements for these information areas. In this case, a plurality of information areas and conditional statements may be combined. The system user determines processing operations for the combinations and sets it for the system.

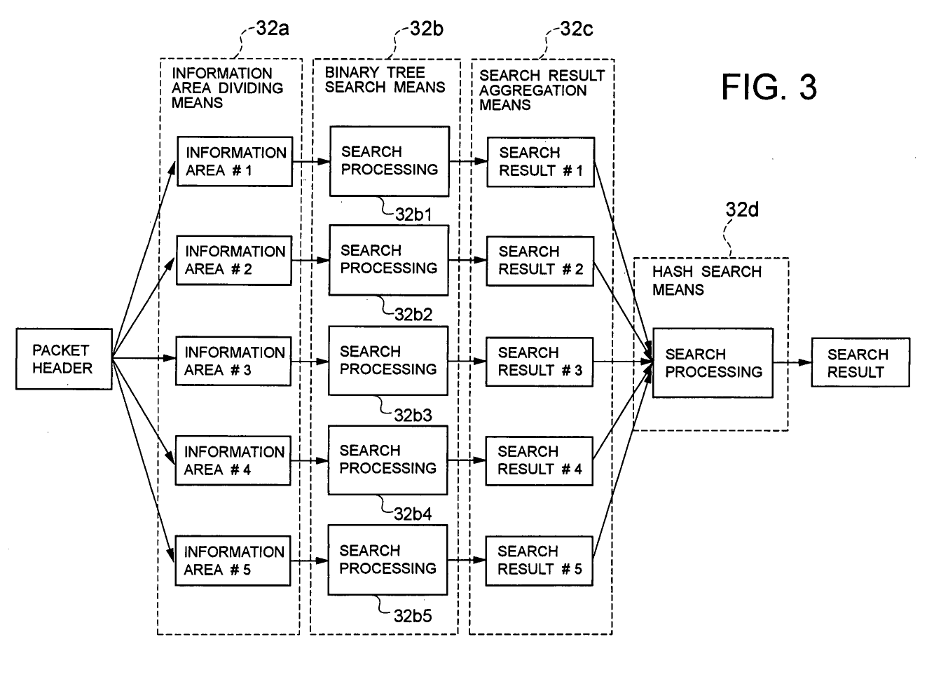

FIG. 3 is a block diagram showing processing blocks in the search processing operation device. 32. As shown, the search processing operation device 32 consists of information area dividing means 32a, binary tree search means 32b, search result aggregation means 32c, and Hash searching means 32d.

The information area dividing means 32a divides header information of received packet data into a number of information areas #1 to #5 that are used for search. For example, in the IP header A2 in FIG. 2, information area #1 is “destination IP address”, information area #2 is “source IP address”, information area #3 is “service type”, information area #4 is “protocol”, and information area #5 is “packet length”. However, the number of information areas is not limited to this number and the subjects of information areas are not limited to this example either.

The binary tree search means 32b executes search processing 32b1 to 32b5 that correspond to the information areas #1 to #5 divided by the information area dividing means 32a. Given the information areas #1 to #5 as input, the search processing 32b1 to 32b5 outputs their IDs if they match conditional statements that have been defined.

The search result aggregation means 32c aggregates IDs when IDs are sent as search results for each information area by the binary tree search means 32b. The Hash search means 32d determines the final processing operation by performing searches utilizing Hash method on the search results for each information area provided by the binary tree search means 32b, which have been aggregated by the search result aggregation means 32c.

At the time the search processing by the binary tree search means 32b and Hash search means 32d is complete, it becomes possible for the packet search device 3 to search for a processing operation based on a packet header provided to it. Further, the embodiment can perform the search processing speedily and simplify the management of the search management table.

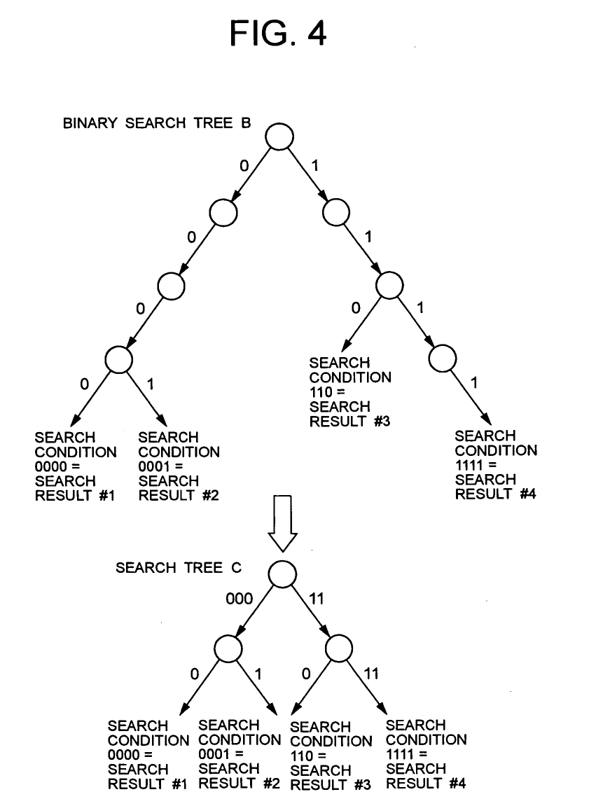

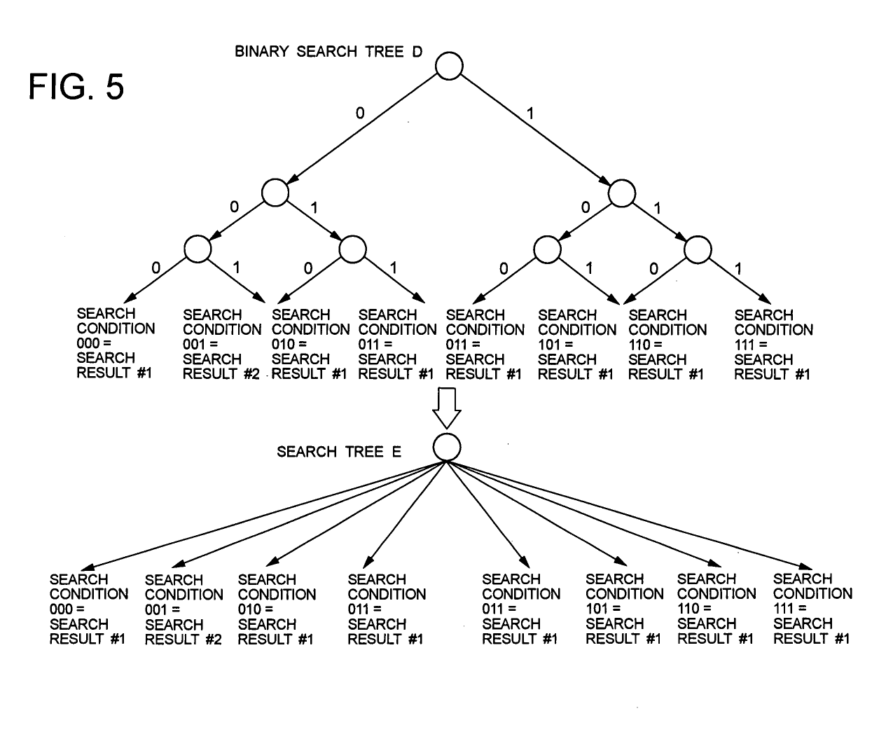

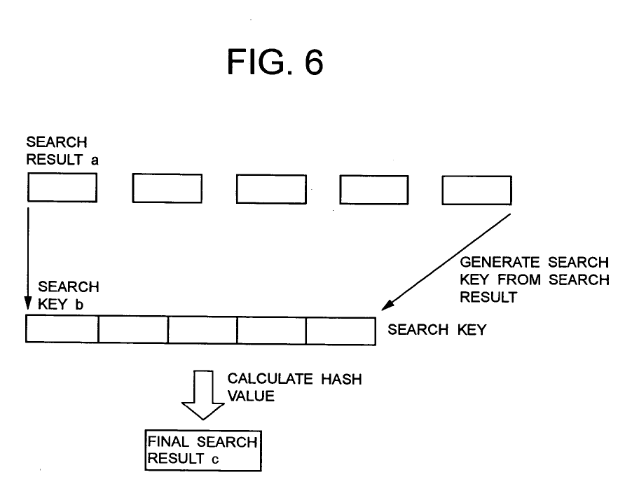

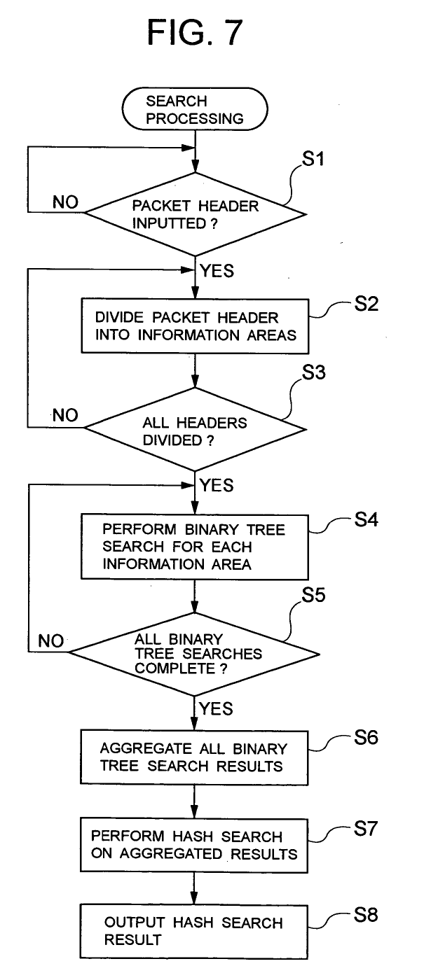

FIG. 4 shows an example of optimization of a search tree in an embodiment of the invention; FIG. 5 shows an example of optimization of a search tree in an embodiment; FIG. 6 generally shows search processing in an embodiment; and FIG. 7 is a flowchart showing search processing in an embodiment. In the following, search processing in an embodiment will be described with reference to FIGS. 1 to 7. The process shown in FIG. 7 is implemented by a computer executing a program stored in the recording medium 33.

Header information in received packet data is transferred to the search processing operation device 32. Header information can be divided into a number of information areas. Processing operations for packet data are determined by the system user using the information areas.

First, in the search processing operation device 32, header information of received packet data is divided into a number of information areas #1 to #5 that are used for searching by the information area dividing means 32a as shown in FIG. 3 (steps S1 to S3 in FIG. 7), and then the binary tree search means 32b executes search processing 32b1 to 32b5 that correspond to the information areas #1 to #5 (steps S4 and S5 in FIG. 7). If the information areas #1 to #5 given as input match predetermined conditional statements, the search processing 32b1 to 32b5 each outputs IDs for search results.

This embodiment performs binary tree search is as search processing 32b1 to 32b5. Current filtering conditions need even specification by source ports and destination ports of TCP packets and UDP packets as well as range specification by decimal numbers. If such filtering conditions are specified, use of Hash method would require a lot of Hash tables and complicate database management. Thus, the embodiment adopts binary tree search described above.

In the search processing 32b1 to 32b5, search tree are divided since searches are performed for each information area separately As a result, search trees can be managed as ones that are smaller than one that is not divided, thus editing processing of search trees is curtailed. Also, because the search processing 32b1 to 32b5 involve no interdependency among them, the search processing can be carried out in parallel, thereby speeding up the search processing. Further, by structuring arithmetic circuits as multiple stages, the processing 32b1 to 32b5 can be pipelined to improve processing capability. The processing 32b1 to 32b5 may be executed serially and sequentially or may be combined.

The embodiment also optimizes search trees. Using a general method for search tree optimization such as one described in the second prior art, nodes of a binary tree B that do not have two branches are each compressed to one branch condition (search tree C) as shown in FIG. 4. As a result, the embodiment can speed up processing and reduce required storage area by using the search tree C.

As a technique for further speeding up search of a search tree, the embodiment further reduces a partial tree D whose branches all bifurcate to a node that has two or more branches (search tree E). In the example shown in FIG. 5, search of the tree not thus reduced requires three comparisons, whereas only one comparison is required after the reduction as shown by the search tree E, thereby speeding up search processing.

Thus, search trees are optimized through the compression shown in FIG. 4 and reduction in FIG. 5. The embodiment does not perform this optimization for a complete search tree but divides a tree into 8-bit regions before optimization. Although a search tree that is optimized in its entirety without division has better processing speed and storage area, when a new conditional statement is additionally registered or a conditional statement that is already set is deleted, the optimized search tree need to be re-edited entirely, the editing thus takes more time.

The reason for the division unit is 8 bits is that a network address itself that is used as one of the information areas is managed as divided into 8-bit units. Thus, because the difference between the values of conditional statements is divided by 8 bits, a search tree that is optimized after being divided and one that is optimized without division will have only small differences of processing capability and storage area.

At the stage of search processing 32b1 to 32b5 by the binary tree search means 32b, an ID for search result is obtained for each information area. However, a final search result is determined by combination of search processing 32b1 to 32b5. Thus, the plurality of search results are aggregated by the search result aggregation means 32c (step S6 in FIG. 7), and the eventual processing operation is determined by the Hash search means 32d from the aggregated search results (steps S7 and S8 in FIG. 7).

The Hash search means 32d utilizes Hash method to perform search on the search results aggregated by the search result aggregation means 32c. In this case, as shown in FIG. 6, a single fixed table (search key b) is generated from the IDs of a plurality of search results a's. The table has predetermined locations for storing each information area.

Hash values derived from this table thus have such a property that Hash values indicate assume different values if IDs for search results are different because Hash functions are one-way functions, so that combination of condition results can be discriminated and the final result c can be obtained. As mentioned above, management with Hash values permits speeding up of processing. Also, because table management is done with ID values for search results, less Hash values are required.

At the point search processing by the binary tree search means 32b and the Hash search means 32d, the packet search device 3 can search for a processing operation with a provided packet header. The embodiment can perform the search processing speedily and simplifies the management of the search management table.

For example, if search is performed for a 32-bit IP address and 16-bit application information (TCP port information), the embodiment reduces each of the 32-bit IP address and 16-bit application information to a 8-bit ID before calculating Hash values. Thus, the processing can be speeded up compared with conventional processing in which Hash values are calculated from the 32-bit IP address and 16-bit application information, and management of the search management table for the search can be simplified.

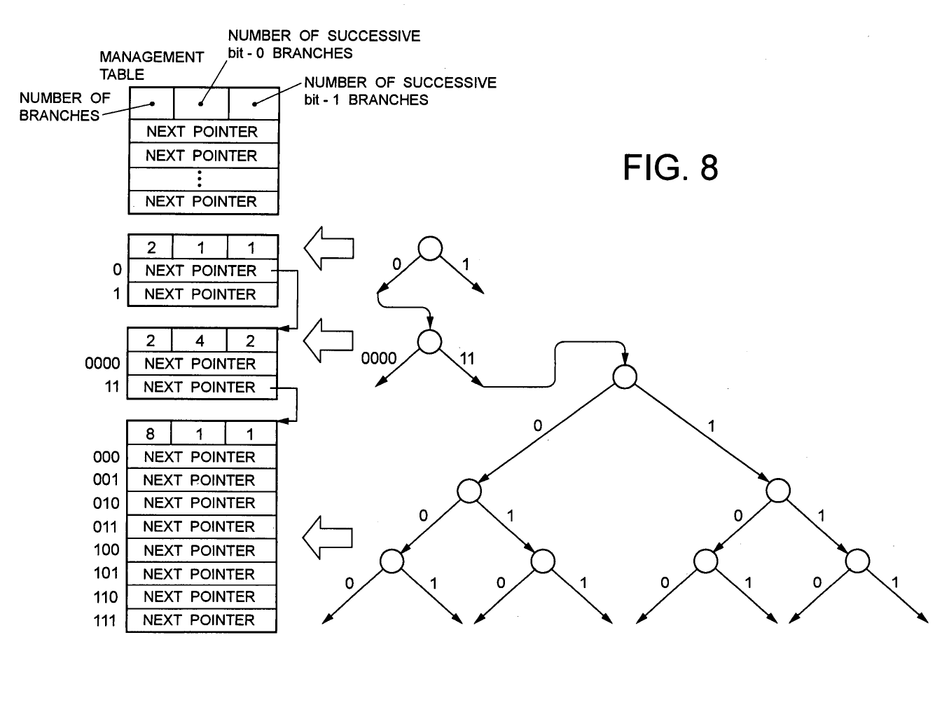

FIG. 8 shows an example of configuration of a management table for search trees in an embodiment. As shown in the figure as a specific example of search tree implementation, if such a management table is implemented that stores, as information for each node, the number of compressed bits 0 (the number of successive bit-0 branches), the number of compressed bits 1 (the number of successive bit-1 branches), the number of branches, the memory address of a node to which each branch connects (next pointer), collective management of information on compressed or aggregated nodes is enabled and the table can be implemented in a single memory. Also, if storage devices can be implemented for each search tree, the problem of memory access conflict can be mitigated.

The following description will specifically consider how to manage search conditions. The system user registers or deletes conditional statements for each information areas of header information. In this case, because control device 5 divides search trees, the registration/deletion can be realized by editing only search trees corresponding to information areas for which the registration/deletion is performed.

The system user then registers/deletes “processing operations” such as actual filters and QoS and “combination of information areas with conditional statements” for the processing operations. In a case of registration, because conditional statements are already registered as search trees, a Hash value is calculated by the Hash search means 32d from combination of conditional statements, and the processing operation is described in a table that is addressed by the Hash value (the next pointer).

In a case setting of a processing operation is deleted, search trees need not to be edited and deletion can be done just by deleting the table corresponding to the Hash value. Thus, the control device thus 5 can easily register/delete search conditions and corresponding processing operations.

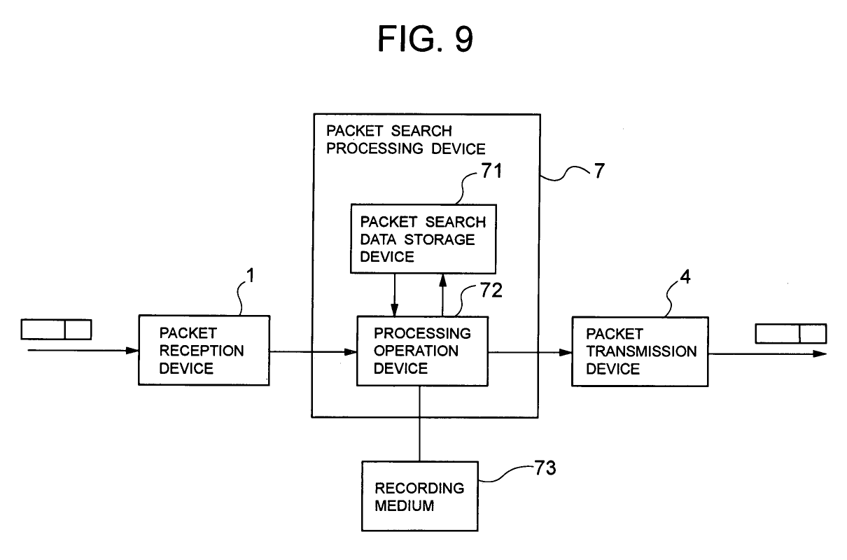

FIG. 9 is a block diagram showing the configuration of a packet processing search system according to another embodiment of the invention. The packet processing search system shown in FIG. 9 has a configuration similar to the system of another embodiment shown in FIG. 1 except that it is provided with a packet search processing device 7 that integrates the packet processing device 2 and packet search device 3 of FIG. 1, the same components are denoted with the same numerals.

The packet search processing device 7 comprises a processing operation device 72 for executing packet processing and packet searching, a packet search data storage device 71 for storing packet data, a packet filtering search database and processing, and a recording medium 73 for storing programs to be executed by a computer in a case the search processing operation device 72 is implemented with a computer.

The processing operation device 72 receives packet data, divides it into information areas, performs searches by means of search trees, and compiles the result into a table and calculates Hash values. As a result, the device 72 performs a series of processing of determining a processing operation and processing packet data with a single arithmetic circuit.

It is also possible that the series of processing operation instructions are stored in the recording medium 73 and executed by a general purpose processor. Thus, by performing a series of processing of determining a processing operation and processing packet data with a single arithmetic circuit, the system can be more compact and expandable.

Although an embodiment of invention executes packet processing and search processing with separate processors, processing speed can be improved sufficiently if the searching technique according to the embodiment described previously is applied as it is as software processing by a generic processor as in this embodiment.

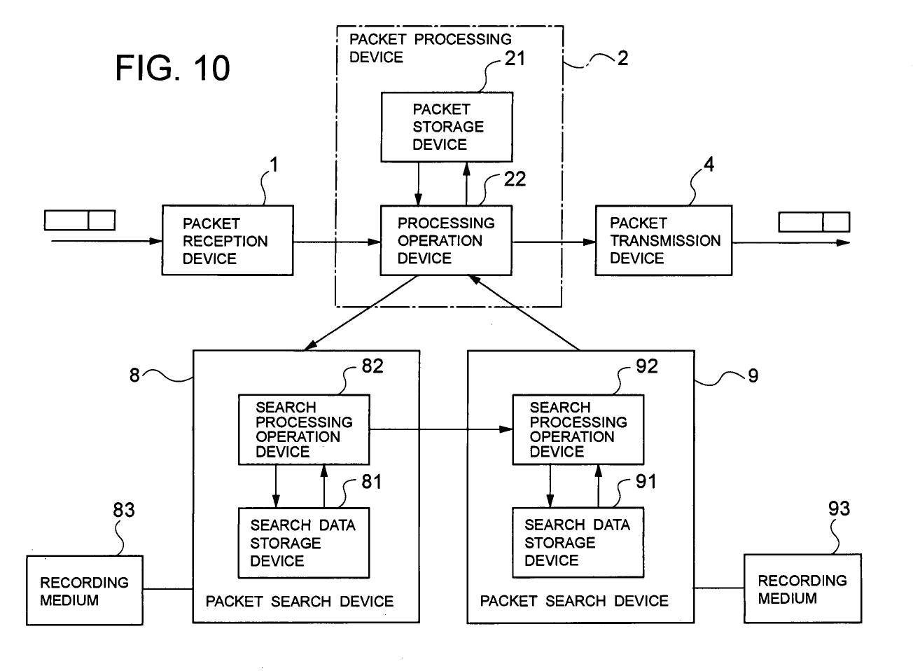

FIG. 10 is a block diagram showing the configuration of a packet processing search system according to another embodiment of the invention. The packet processing search system shown in FIG. 10 has a configuration similar to that of the system in FIG. 1 except that the packet search device 3 in FIG. 1 is divided into a packet search device 8 for performing search of packet conditional statements and a packet search device 9 for performing search of packet condition combinations, the same components are denoted with the same numerals.

The packet search device 8 performs only search processing that is done by the binary tree search means 32b shown in FIG. 3, receiving packet headers from the packet processing device 2, dividing them into information areas, and performing search processing with search trees. The packet search device 8 returns the result to the packet search device 9.

Upon receiving the result of search processing for each search tree from the packet search device 8, the packet search device 9 executes only search processing that is executed by the Hash search means 32d shown in FIG. 3 for the result and returns the search result to the packet processing device 2. The packet search devices 8 and 9 comprise storage media 83 and 93 respectively that store programs to be executed by a computer in a case the search processing operation devices 82 and 92 are implemented as computers.

Because in this embodiment search processing by the binary tree search means 32b and that by the Hash search means 32d shown in FIG. 3 involve no processings that are interdependent for search conditions, each processing operation can be distributed to separate devices, and thus processing speed can be further improved more than in the configuration shown in FIG. 1.

As thus described, the invention can speed up management of a search database since each search conditional statement is implemented as a binary tree and combinations of multiple search conditional statements are managed through Hash method.

Also, the invention can improve operability, maintainability, and security because a controlling CPU can focus on processing of routing protocols and the like.

The invention further allows a search system to be built that can provide processing capability required from a search system and expandability since software implementation permit a plurality of arithmetic circuits to operate in parallel through pipelining.

As has been described, the invention provides an advantage that management of a search database can be speeded up and simplified without slowing down the search processing by dividing packet search processing into the first and second processing stages, and searching for filter information using search methods different at each of those stages, in a packet processing search system that searches for packet filters before performing packet processing.

What is claimed is:

1. A packet search device that performs packet filter search for an inputted packet, comprising:
a first search processing means for searching for search conditional statements corresponding to a plurality of information areas included in header information of said packet with a first search method; and
a second search processing means for searching the search results of said first search processing means with a second search method that is different from said first search method.

2. The packet search device according to claim 1, wherein said first search processing means divides said packet header information into a plurality of information areas and searches across each search conditional statements structured as binary search trees for each of said information areas separately.

3. The packet search device according to claim 2, wherein said second search processing means searches aggregated search results of said first search processing means using Hash method.

4. The packet search device according to claim 1, comprising a search database for managing each search result of said first and second search processing means for each of said information area.

5. The packet search device according to claim 4, wherein said search database has a plurality of search keys.

6. The packet search device according to claim 3, wherein said second search processing means manages only combinations of search results.

7. The packet search device according to claim 1, wherein at least QoS (Quality of Service) information and filter information are searched for based on said header information.

8. The packet search device according to claim 1, wherein said packet search processing is performed at least in a router and a firewall.

9. A packet processing search method that searches for a packet filter for an inputted packet before performing packet processing, comprising:
a first step of searching for search conditional statements corresponding to a plurality of information areas included in header information of said packet with a first search method; and
a second step of searching the search results at said first step with a second search method that is different from said first search method.

10. The packet processing search method according to claim 9, wherein said first step divides said packet header information into a plurality of information areas and searches across each search conditional statements structured as binary search trees for each of said information areas separately.

11. The packet processing search method according to claim 10, wherein said second step searches aggregated search results of said first step using Hash method.

12. The packet processing search method according to claim 9, wherein each search result at said first and second steps is managed for each of said information areas using a search database.

13. The packet processing search method according to claim 12, wherein said search database has a plurality of search keys.

14. The packet processing search method according to claim 11, wherein said second step manages only combinations of search results.

15. The packet processing search method according to claim 9, wherein at least Qos (Quality of Service) information and filter information are searched for based on header information in said packet.

16. The packet processing search method according to claim 9, said packet search processing is performed at least in a router and a firewall.

17. A program for a packet processing search method that searches for a packet filter for an inputted packet before performing packet processing, causing a computer to execute,
first processing that searches for search conditional statements corresponding to a plurality of information areas included in header information of said packet with a first search method; and
second processing that searches the search results of said first processing with a second search method that is different from said first search method.
